(19) United States
(12) Patent Application Publication
(10) Pub. No.: US 2026/0139120 A1
(43) Pub. Date: May 21, 2026

(54) METHOD FOR FABRICATING COMPOSITE MATERIALS WITH DIRECT CAPTURE NANOSCALE PARTICLES AND SUSTAINABLE MACROSCALE FIBERS USING A WET-LAID PROCESS

(71) Applicant: Endeavor Composites, Inc., Knoxville, TN (US)

(72) Inventors: Anna E. Douglas, Knoxville, TN (US); Hicham Ghossein, Knoxville, TN (US)

(21) Appl. No.: 19/392,896

(22) Filed: Nov. 18, 2025

Related U.S. Application Data
(60) Provisional application No. 63/721,121, filed on Nov. 15, 2024.

(51) Int. Cl. C08K 3/04; C08K 7/06; C08K 7/18; C08K 11/00; C08L 101/00

(52) U.S. Cl. CPC C08K 3/041; C08K 7/06; C08K 7/18; C08K 11/00; C08L 101/00; C08K 2201/004; C08K 2201/011

(57) ABSTRACT

A method of manufacturing composites is described herein. The composites are made from a composite materials including electrochemically-synthesized carbon structures manufactured using CO₂ as a carbon source. The composite structures can further include cellulosic fibers and carbon waste fibers. The composites are manufactured in a system for dispersing the polymer composite material in a medium. The system includes a vessel configured to receive a volume of a medium including a quantity of fibers; one or more agitators that each comprise a stirring element that is movable in a pattern within the vessel to mechanically agitate the medium; and a drive system connected to the one or more agitators, the drive system comprising a gear assembly configured to translate rotation of the gear assembly into a pattern of movement for a respective stirring element.

### CROSS REFERENCE TO RELATED APPLICATIONS

This application claims the priority benefit of U.S. Provisional Patent Application No. 63/721,121, filed Nov. 15, 2024, which is hereby incorporated herein by reference in its entirety.

### FEDERALLY SPONSORED RESEARCH AND DEVELOPMENT

This invention was made with government support under Cooperative Agreement award No. DE-AR0001643 awarded by Department of Energy's Advanced Research Projects Agency-Energy (ARPA-E). The government has certain rights to this invention.

### TECHNICAL FIELD

This disclosure pertains to the field of composite materials, and in particular composite materials that include materials derived from CO₂.

### BACKGROUND OF THE INVENTION

Composite materials have many applications and are found throughout modern life. In particular, composites that are made by combining reinforcing fibers and a polymer matrix can be formed into a wide variety of shapes. By nature, these composite materials are at once lightweight and extremely strong. Of the various composite materials, those including carbon containing fibers find many uses, and are referred to variously as “carbon fiber composites,” CFP, carbon fiber reinforced composites, or even simply “carbon fiber.”

Although carbon fibers provide a very high degree of strength to such composites, conventional carbon fibers are made from non-renewable mineral resources such as oil and natural gas. This is problematic because conventional processing of these mineral resources emits CO₂ into the atmosphere which increases anthropogenic global warming. Parts made from mineral resources are sometimes said to have embodied carbon because their production emits a certain amount of CO₂ into the atmosphere, and that emitted carbon is thereby “embodied” in each part.

It is also problematic because fundamentally, carbon fibers are made of carbon and could conceivably be formed from the CO₂ that is already present in the atmosphere. If carbon fibers could be formed from the CO₂ present in the atmosphere and be formed into a carbon fiber composite, the resulting carbon fiber composite would not only serve its intended purpose (for example, as a useful structural member that is lightweight and strong), but it would also have a negative embodied carbon because each manufactured part would remove CO₂ from the atmosphere. The present disclosure is directed to carbon fiber composites and methods for their manufacture having negative embodied carbon.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a flow diagram of a method of manufacturing a polymer composite material in accordance with one aspect of the disclosure;

FIGS. 2A through 2C are schematic side views of steps in a wet-laid technique for producing nonwoven mats according to an embodiment of the presently disclosed subject matter; and

FIG. 3 is a schematic top view of a mixer according to an embodiment of the presently disclosed subject matter.

### DETAILED DESCRIPTION

The following description of certain examples of the technology should not be used to limit its scope. Other examples, features, aspects, versions, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

In one or more versions, the present disclosure relates to the field of nonwoven fabric manufacturing, specifically focusing on a wet-laid fabrication method for producing multiscale nonwoven materials that integrate direct capture CO₂ derived nanoscale particles and macroscale fibers. The process may be designed to achieve a homogenous, isotropic structure using a specialized mixing system capable of suspending long fibers without entanglement, enabling the creation of advanced nonwoven fabrics. These materials may exhibit unique mechanical and structural properties suited for applications in high-performance sectors, such as aerospace, automotive, construction and other industries requiring lightweight, durable, and multifunctional composite materials. The present disclosure addresses the technical challenges of achieving uniform distribution of fibers across scales, enhancing fabric consistency and performance.

The integration of nanoscale particles into nonwoven fabrics presents a unique challenge due to the tendency of these particles to agglomerate, particularly when introduced into aqueous solutions. Nanoscale particles, such as carbon nanotubes, graphene, and nano-silica, possess a high surface area and strong intermolecular forces that cause them to cluster together, forming aggregates. This agglomeration significantly limits their dispersion within a water-based medium and, consequently, reduces their distribution uniformity in nonwoven structures. Nonwoven fabrics, especially those produced via wet-laid methods, require a consistent distribution in the system to form a uniform fabric. The presence of clustered nanoscale particles disrupts this balance, leading to weak points within the fabric and compromising the intended mechanical properties.

There have been previous attempt at addressing the dispersion of fibers, particularly carbon fibers, in wet-laid nonwoven systems. For example, one previous attempt focused primarily on achieving a uniform suspension of larger fibers. However, this attempt did not address the specific challenges associated with nanoscale particles. The procedures and mechanisms required to overcome nanoscale particle agglomeration remain inadequately detailed in prior attempts at solving for this issue, especially for applications where both nanoscale and macroscale elements must coexist within a single fabric.

The current disclosure seeks to bridge this gap by introducing a novel process for incorporating nanoscale particles alongside long macroscale fibers within a wet-laid system. The current disclosure mitigates agglomeration and achieves a stable, uniformly distributed fabric structure. By addressing both the dispersion challenges of nanoscale particles and the entanglement tendencies of long fibers, this process may enable the production of multiscale nonwoven fabrics that maintain isotropic properties and enhanced performance characteristics. The present disclosure may be poised to meet the increasing demand for multifunctional materials in industries such as aerospace and automotive, where lightweight and durable composites are essential.

### Composite

Composite materials may be assembled using electrochemically-synthesized carbon structures. The electrochemically-synthesized carbon structures may be derived from a CO₂ source. In some embodiments, the electrochemically-synthesized carbon structures are produced using atmospheric CO₂. In some embodiments, the composite materials comprise one or more of cellulosic fibers or carbon waste fibers. In some embodiments, the composite materials have a negative embodied carbon. In some embodiments, the composite material may be one or more of a sandwich composite, a fiber reinforced composite, or a particle reinforced composite. In some embodiments, at least one layer of the sandwich composite comprises the electrochemically-synthesized carbon structures.

In some embodiments, the composite material may include a polymer composite material comprising electrochemically-synthesized carbon structures. In some embodiments, the electrochemically-synthesized carbon structures may include one or more of carbon nanotubes, carbon black, carbon fibers, carbon zoo, carbon flakes, carbon spherical particles. In some embodiments, the electrochemically-synthesized carbon structures may be formed using a CO₂ source. The CO₂ source may be any source effective for the formation of carbon structures using electrosynthesis. In some embodiments, the CO₂ source may be atmospheric CO₂.

The electrochemically-synthesized carbon structures may be present in the composite material in any amount. In some embodiments, the electrochemically-synthesized carbon structures may be present in the composite material in an amount of about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10.0 wt. %, about 15 wt. %, about 20 wt. %, about 25 wt. %, about 30 wt. %, about 35 wt. %, about 40 wt. %, about 45 wt. %, about 50 wt. %, or any value or range of value between any two of these values. In some embodiments the electrochemically-synthesized carbon structures are present in the composite material in an amount of about 0.5 wt. % to about 50 wt. %, or about 0.5 wt. % to about 10 wt. %.

In some embodiments, the electrochemically-synthesized carbon structures include carbon fibers. The carbon fibers may have any length effective as a fiber in a composite material. In some embodiments, the carbon fibers may have an average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10.0 mm, about 15 mm, about 20 mm, about 25 mm, about 30 mm, about 35 mm, about 40 mm, about 45 mm, about 50 mm, or any value or range of values between any two of these values.

The carbon fibers may have any diameter effective as a fiber in a composite material. In some embodiments, the carbon fibers may have an average diameter of about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, or any value or range of values between any two of these values.

In some embodiments, the electrochemically-synthesized carbon structures may include carbon nanotubes. In some embodiments, the carbon nanotubes may include single-walled carbon nanotubes. In some embodiments, the carbon nanotubes may include multi-walled carbon nanotubes. The carbon nanotubes may have any diameter effective as a fiber in a composite material. In some embodiments, the carbon nanotubes may have an average diameter of about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, or any value or range of values between any two of these values.

In some embodiments, the composite material may also include a resin. The resin may include any resin known to one of skill in the art effective for use in a composite material. In some embodiments, the resin may include one of a polymer resin or a bio-resin. In some embodiments, the resin comprises one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate.

In one or more embodiments, the resin may be present in the composite material in any amount. In some embodiments, the resin may present in the composite material in an amount of about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, or any value or range of value between any two of these values.

In some embodiments, the composite material may include one or more cellulosic fibers. The cellulosic fiber may be from any material effective for use in a fiber of a composite material. In some embodiments, the one or more cellulosic fibers may include one or more of bamboo, rice husk, rice straw, sugarcane, pineapple, coconut, cellulose, jute, bagasse, nettle, cotton, hemp, banana, and flax. The cellulosic fibers may be present in the composite material in any amount. In some embodiments, the cellulosic fibers may be present in the composite material in an amount of about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, or any value or range of value between any two of these values. In some embodiments the cellulosic fibers may be present in the composite material in an amount of about 20 wt. % to about 80 wt. %, about 30 wt. % to about 70 wt. %, or about 40 wt. % to about 60 wt. %. In some embodiments, the cellulosic fibers may be present in a weight ratio as compared to the electrochemically synthesized fibers of about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, or any value or range of values between any two of these values.

The cellulosic fibers may have any length effective as a fiber in a composite material. In some embodiments, the cellulosic fibers may have an average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10.0 mm, about 15 mm, about 20 mm, about 25 mm, about 30 mm, about 35 mm, about 40 mm, about 45 mm, about 50 mm, or any value or range of values between any two of these values.

In some embodiments, the composite material may include carbon waste fibers. In some embodiments, the carbon waste fibers may include one or more of recycled carbon fibers or reclaimed carbon waste fibers. In some embodiments, the carbon waste fibers may include waste fibers from carbon fiber production. In some embodiments, the carbon waste fibers may include chopped carbon fibers. The cellulosic fibers may be present in the composite material in any amount. In some embodiments, the carbon waste fibers may be present in the composite material in an amount of about 1 wt. %, about 2 wt. %, about 3 wt. %, about 4 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, or any value or range of value between any two of these values. In some embodiments the carbon waste fibers may be present in the composite material in an amount of about 20 wt. % to about 80 wt. %, about 30 wt. % to about 70 wt. %, or about 40 wt. % to about 60 wt. %. In some embodiments, the carbon waste fibers may be present in a weight ratio as compared to the electrochemically synthesized fibers of about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, about 1:50, about 1:100, about 1:200, about 1:300, about 1:400, about 1:500, about 1:600, about 1:700, about 1:800, about 1:900, about 1:1000, or any value or range of values between any two of these values.

The carbon waste fibers may have any length effective as a fiber in a composite material. In some embodiments, the carbon waste fibers may have an average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10.0 mm, about 15 mm, about 20 mm, about 25 mm, about 30 mm, about 35 mm, about 40 mm, about 45 mm, about 50 mm, or any value or range of values between any two of these values. In some embodiments, the carbon waste fibers may have an average length greater than about 3 mm.

In some embodiments the composite materials may include one or more additional additives. The one or more additional additives may include any material effective for use in composite materials. In some embodiments, the one or more additional additives may include one or more of coupling agents, colorants, plasticizers, fillers, pigments, glass fibers, or flame retardants. The one or more additional additives may be present in the composite material in any amount. In some embodiments, the carbon waste fibers may be present in the composite material in an amount of about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, or any value or range of value between any two of these values.

### Methods of Manufacturing

Methods may be assembled to aid in the manufacturing of the composite materials described above.

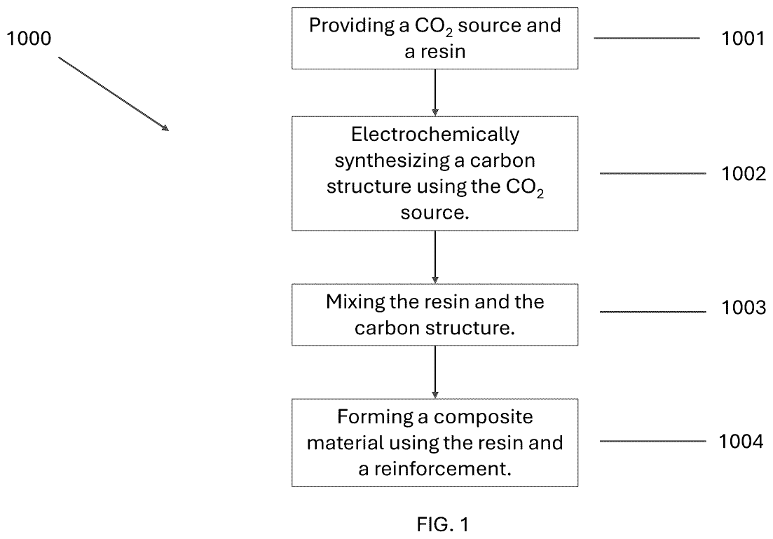

FIG. 1 depicts an illustrative flow diagram of a method 1000 of manufacturing a composite material. The method may include providing a CO₂ source and a resin at a step 1001. The CO₂ source may be any source effective for the electrochemical synthesis of carbon structures. In some embodiments, the CO₂ source may be one or more of industrial waste exhaust or atmospheric CO₂. In one or more embodiments, the industrial waste exhaust may be from any process which produces CO₂ gas emissions such as, but not limited to, a power plant, a chemical processing plant, a steel plant, and/or a cement plant. The resin may be any resin effective for use in a composite material. In some embodiments, the resin includes one or more of polyester, epoxy, vinyl ester, phenolic, polyurethane, ABS, polyethylene, polystyrene, polypropylene, PA6, PLA, acrylic resin, PI ULTEM, PEEK, biopolyesters, cellulose, biopolyolefins and polycarbonate.

The method may further include electrochemically synthesizing carbon structures using the CO₂ source at a step 1002. The carbon structures may include any structure effective for use in a composite material. In some embodiments, the carbon structures may include one or more of carbon nanotubes, carbon black, carbon fibers, carbon zoo, carbon flakes, and/or carbon spherical particles.

The method may further include forming a composite material using the carbon structures at a step 1003. The composite material may be formed at step 1003 by any process effective for producing composites known to one of skill in the art. In some embodiments, the reinforcement may include one of a non-woven fabric or a woven fabric. In some embodiments, the reinforcement formed at step 1003 may be formed using a wet-laid non-woven fabrication process.

The method may further include forming a composite material using the resin and the reinforcement at a step 1004. The composite material may be formed at step 1004 by any process effective for producing composites known to one of skill in the art. In some embodiments, the composite material may be formed by one of melt processing, injection molding, wet laying, resin filling, compressing molding, resin transfer molding, or spray up. The composite material may be formed at step 1004 with any ratio of the reinforcement to the resin effective for use as a composite material. In some embodiment, the weight ratio of the carbon structures to the resin may be about 2:1, about 1:1, about 1:2, about 1:3, or any value or range of values between any two of these values. The composite material formed at step 1004 may be formed with any ratio of the carbon structures to the resin effective for use as a composite material. In some embodiments, the weight ratio of the carbon structure to the resin may be about 1:120, about 1:100, about 1:80, about 1:60, about 1:40, about 1:20, about 1:10, about 1:5, about 1:4, about 1:3, about 1:2, about 2:3, or any value or range of values between any two of these values.

In some embodiments, the method may further include providing cellulosic fibers and forming the polymer composite material using the cellulosic fibers. The cellulosic fibers may include any fibers effective for use in a composite material. In some embodiments, the cellulosic fibers may include one or more of bamboo, rice husk, rice straw, sugarcane, pineapple, coconut, cellulose, jute, bagasse, nettle, cotton, hemp, banana, and flax. The composite material may be formed with any ratio of the carbon structure to the cellulosic fibers effective for use as a composite material. In some embodiments, the weight ratio of the carbon structures to the cellulosic fibers may be about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, or any value or range of values between any two of these values. In one or more embodiments, the weight ratio of the carbon structure to the cellulosic fibers may be between about 1:1 and about 1:2.

In some embodiments, the method may further include providing carbon waste fibers and forming the polymer composite material using the carbon waste fibers. The carbon waste fibers may include any fibers effective for use in a composite material. In some embodiments, the carbon waste fibers may include one or more of recycled carbon fibers or reclaimed carbon waste fibers. The composite material may be formed with any ratio of the carbon structure to the carbon waste fibers effective for use as a composite material. In some embodiments, the weight ratio of the carbon structures to the carbon waste fibers may be about 10:1, about 9:1, about 8:1, about 7:1, about 6:1, about 5:1, about 4:1, about 3:1, about 2:1, about 1:1, about 1:2, about 1:3, about 1:4, about 1:5, about 1:6, about 1:7, about 1:8, about 1:9, about 1:10, or any value or range of values between any two of these values. In one or more embodiments, the weight ratio of the carbon structures to the carbon waste fibers may be between about 1:1 and about 1:2.

In some embodiments, the method may further include chopping the carbon waste fibers prior to forming the composite material. The carbon waste fibers may be chopped to any length effective for use in a composite material. In some embodiments, the carbon waste fibers may be chopped to average length of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 1.5 mm, about 2.0 mm, about 2.5 mm, about 3.0 mm, about 3.5 mm, about 4.0 mm, about 4.5 mm, about 5.0 mm, about 5.5 mm, about 6.0 mm, about 6.5 mm, about 7.0 mm, about 7.5 mm, about 8.0 mm, about 8.5 mm, about 9.0 mm, about 9.5 mm, about 10.0 mm, about 15 mm, about 20 mm, about 25 mm, about 30 mm, about 35 mm, about 40 mm, about 45 mm, about 50 mm, or any value or range of values between any two of these values. In one or more embodiments, the carbon waste fibers may be chopped to an average length greater than about 1 mm or greater than about 3 mm.

In some embodiments, the method may further include providing one or more additional additives and forming the composite material using the one or more additional additives. The one or more additional additives may include any material known to one of skill in the art effective for use in a composite material. In some embodiments the additional additive may include one or more of coupling agents, colorants, plasticizers, fillers, pigments, glass fibers, or flame retardants. The composite material may be formed with any ratio of the carbon structure to the additional additives effective for use as a composite material. In some embodiments, the weight ratio of the carbon structures to the additional additives may be about 200:1, about 150:1, about 100:1, about 90:1, about 80:1, about 70:1, about 60:1, about 50:, about 40:1, about 30:1, about 20:1, 10:1, about 9:1, about 8:1, about 7:1, about 6:1, about 5:1, about 4:1, about 3:1, about 2:1, about 1:1, about 1:2, about 1:3, about 1:4, about 1:5, or any value or range of values between any two of these values.

In one or more versions, composites utilizing the material formed as discussed above may be made utilizing the following system and mixing regime. The proposed mixing design and development of wet laid nonwoven fiber mats may provide a potential opportunity to expand applications with nonwoven fiber mats. Although wet laid mats can generally have random fiber orientation, such techniques offer a way to produce nonwoven mats with fiber length retention and an ability to tailor fiber orientation.

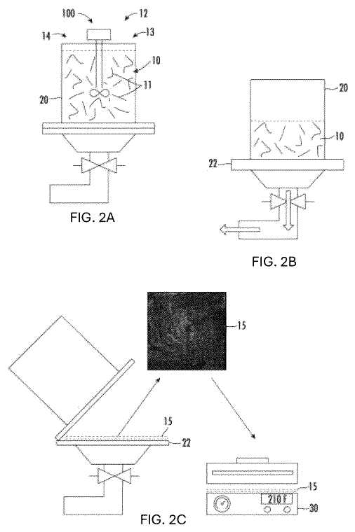

In one aspect, the present disclosure provides systems and methods for producing non-woven mats having fibers incorporated therein from a uniform dispersion of fibers in a medium. The present methods can comprise three main process regimes as shown schematically in FIGS. 2A through 2C. First, in some embodiments, a quantity of fibers are dispersed in a medium 10 contained within a vessel 20 as shown in FIG. 2A. Once the fibers are dispersed in medium 10, the fluid can be removed from the vessel to produce a continuous or discontinuous web formation on a surface. In some embodiments, for example, the fluid can be filtered through a screen 22 provided within vessel 20 as shown in FIG. 2B, and fibers 11 can be thereby deposited on screen 22 in the form of a two-dimensional non-woven web 15. After filtering out the fluid, non-woven web 15 can be post-processed to achieve the desired form. In some embodiments, such post-processing can include one or more of solidification, drying, and winding up of non-woven web 15. As shown in FIG. 2C, for example, non-woven web 15 can be transferred to a dryer 30. Such methods can be used to produce non-woven mats having improved fiber distribution and consistent repeatability.

Referring again to FIG. 2A through 2C, in a first step a quantity of fibers 11 may be dispersed in medium 10, which can be a solution, contained within vessel 20. In some embodiments, for example, carbon fibers may be dispersed in water, such as un-sized chopped Zoltek™ PX35 Type 02 carbon fiber with a length of 25.4 mm, and average diameter of 7 μm. Those having ordinary skill in the art will recognize, however, that the methods disclosed herein can be similarly applied to other kinds of fibers and mediums, including but not limited to glass fibers, Kevlar fibers, basalt fibers, or any of a variety of other man-made or natural fibers known to man, which can be dispersed in any of a variety of mediums other than water, including but not limited to aqueous solutions, alcohols, or hydrogels. In particular, carbon fibers are widely used as reinforcement material in polymer composites, but they have an inert surface and require further treatment. Thus, in some embodiments, medium 10 in which fibers 11 are entrained can be modified by adding additives that enhance the dispersion, wettability, and web formation. There are several example additives that can improve surface wettability of fibers: (a) surfactants 12 are molecules that contain both hydrophilic and hydrophobic moieties, the hydrophobic moieties attach to the hydrophobic fiber and the hydrophilic moieties promote water penetration through the fiber bundle; (b) dispersing agents 13 overcome the hydrophobicity of carbon by creating hydrogen bonds with water molecules; and (c) flocculent agents 14 help the dispersion of fibers, thereby bridging fibers and forming a three dimensional web that collapses into a mat form. In some embodiments, effective proportions of additives may include about 1.5 g of dispersant per cubic foot (Alkyl amine surfactant Nalco 8493™), about 1.5 g of viscosity chemicals agents per cubic foot (anionic flocculent Nalclear 7768™), and about 0.7 g of binder per cubic foot (polyvinyl alcohol (PVOH)) added to the water. Those having ordinary skill in the art will recognize that these additive quantities are merely exemplary, and other quantities and/or different additives can likewise be used to help enhance the dispersion of a given fiber type.

Although additives such as surfactants can assist in initial fiber bundle dispersion, the dispersion of fibers 11 within medium 10 can further be enhanced using mechanical agitation. That being said, wet laid nonwoven fabrics made from synthetic fibers are prone to defects following mechanical agitation. There are two main types of defects that occur during the wet laid process of carbon fiber, such as: a) log defects that can be defined as bundles of fibers that do not disperse, and b) ropes defects which are fiber assemblages that have unaligned ends that are formed by incomplete dispersion of logs or dispersed fibers that spin around each other in a vortex motion. Fiber logs are normally dispersed through the shear force exerted during the mixing process. In order to disperse log defects, shear force must overcome the forces of friction, tension between the fibers, and the drag force applied by the water current as given by Equation 1:

$${F}_{s} > {F}_{st} + {F}_{d} \qquad Eq . ( 1 )$$

where Fₛ is the shear force in Newtons exerted on the fiber bundles by agitation of the liquid, Fₛₜ is the combination of surface tension and friction force between the filaments obtained by Fₛₜ=γL, where γ is the constant of proportionality (coefficient of liquid-surface tension), and L is the fiber length. F_{d} is the drag force that resists fiber dispersion given by Equation 2.

$${F}_{d} = \frac{18 η}{{ρ}_{f} {d}^{2}} \frac{{C}_{D} {R}_{e}}{24} ( {v}_{l} - {v}_{f} ) \qquad Eq . ( 2 )$$

where d and p_{f} are fiber diameter and density respectively, η is liquid dynamic viscosity, C_{D} is the drag coefficient, Rₑ is Reynolds number, vi is liquid linear velocity, and v_{f} is fiber linear velocity.

The flow of a fiber filled viscous media may be controlled mainly through the interactions of fibers at fiber-fiber touch points. A mathematical description of this phenomenon assumes that all such interactions can be formulated as a combination of Coulomb friction between the fibers and hydrodynamic lubrication due to the thin film of liquid between the fibers as given by Equation 3.

$${F}_{s} = η \frac{dU}{dx} \qquad Eq . ( 3 )$$

where dU/dx is defined as the rate of change in velocity across the flow field of the fluid. The agitation flow is characterized by Reynolds number Rₑ that varies between turbulent for Rₑ>4000 and laminar for Rₑ<2000, see Equation 4.

$${R}_{e} = ω {D}^{2} ρ / η \qquad Eq . ( 4 )$$

where ρ is defined as the fluid density, ω is the mixer rpm, and D is the vortex diameter.

The role of fiber properties on the dispersion itself should be considered. Tenacity (Tₜ), that controls the stiffness, crimping and wettability of the fiber, plays an important role on the dispersion quality. The concentration (C_{w}) of dispersion, given by Equation (5), controls the amount of fibers to be dispersed based on their tenacity and length, playing an important role on the final gram per square meter (gsm) count of the nonwoven mat. Fiber length, especially for carbon fiber, is not recommended to exceed 25.4 mm (1 inch) because it will reduce C_{w} and reduces the gsm value of the mat.

$${C}_{w} = 1.7 * \frac{{T}_{t}}{{L}^{2}} \qquad Eq . ( 5 )$$

The conventional method of wet laid production may be divided into two stages. First, a shear mixer is set to a velocity of 1500 RPM causing a single vortex in the same size as the mixing vessel. Substituting the angular velocity in equation (4) yields a Rₑ>4000 causing a turbulent agitation that aims to disperse the logs. At the second stage the mixer velocity is dropped to 300 RPM to obtain a Rₑ<2000 to produce a laminar agitation, based on equation (4), in order to reduce rope formation. It has been indicated that turbulent flow has a powerful effect on rope formation, where the chance of their formation is more likely to occur than in a laminar flow. The reduction of the vortex formation can be a key factor in reduction of rope formation. However, the suppression of the vortex flow may not eliminate the rope defect formation. In a single vortex system, due to constant angular velocity, the fluid may reach a steady state in rotation known as the rigid body motion that causes the fibers to adjust their velocity to that of the fluid, reducing in turn the velocity gradient to a near zero value. Such reduction may eliminate the effect of shear force and result in an increase in defects.

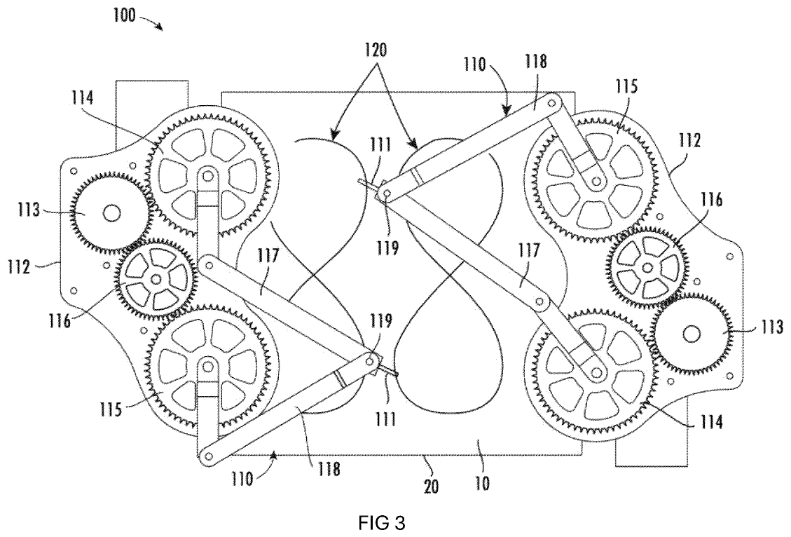

With a carbon fiber length of 25.4 mm, a new system was needed that provides full dispersion through chaotic advection without causing defects in the produced mats. In this regard, in another aspect, the present subject matter provides an improved system for dispersing fibers in a medium. As illustrated in FIG. 3, a mixing system, generally designated 100, may be designed to generate chaotic advection within medium 10 and result in fully dispersed mats. One or more agitators 110 are each separately movable within vessel 20 in patterns 120 that are configured to mechanically agitate medium 10. As shown in FIG. 3, the one or more agitators 110 may include two stirring elements 111, such as paddles, that are each movable within vessel 20 to mechanically agitate medium 10. In some embodiments, stirring elements 111 are composed of Acrylonitrile Butadiene Styrene (ABS), polycarbonate, wood, metal, or any of a variety of other materials that are sufficiently stiff and non-reactive. In some embodiments, three or more stirring elements 111 can be provided, which can in some configurations increase the speed at which the fibers are dispersed within vessel 20.

To control the operation of agitators 110, a drive system 112 may be coupled to each stirring element 111 to move the respective stirring element 111 in a predetermined pattern designed to mechanically agitate medium 10. Each drive system 112 may include a drive gear 113 that may be driven by a power source. In some embodiments, the power source may be a variable speed 12 V DC motor. Drive gear 113 may be coupled for rotation together with a first output gear 114 and a second output gear 115. In some embodiments, second output gear 115 may be rotationally coupled to drive gear 113 by an intervening idler gear 116 that reverses the rotation of second output gear 115 relative to drive gear 113. First drive output gear 114 and second output gear 115 may then be coupled to stirring element 111 by a first connecting arm 117 and a second connecting arm 118, respectively, at a connector 119. In some embodiments, connector 119 may be a hinged connector, and stirring element 111 may be connected in line with a hinge axis. In some embodiments, first and second connecting arms 117 and 118 are offset above the gear assembly in order to provide 360° of clearance for the connecting arms.

With this configuration, the rotation of drive gear 113 drives a complex movement of stirring element 111 within medium 10. Those having ordinary skill in the art will recognize, however, that the embodiment illustrated in FIG. 3 is presented as one exemplary configuration that produces a complex set of complementary patterns of movement 120. Those having ordinary skill in the art will recognize that such a gear-driven configuration achieves a desired patterned motion of stirring element 111 at a low cost compared to other drive mechanisms, although any of a variety of other mechanical configurations for agitators 110 can be used to achieve similar patterns of movement for stirring elements 111. For example, arrangements of computer-controlled linear actuators, robotic arms, or any of a variety of other mechanical systems are capable of reproducing a range of patterns of movement. In some embodiments, drive system 112 may move stirring element 111 in a substantial planar pattern, and the length of stirring element 111 propagates this pattern through the depth of vessel 20 to generate currents throughout vessel 20. Alternatively, or in addition, drive system 112 can be configured to move stirring element 111 in a three-dimensional range of motion to further facilitate movement of fibers throughout vessel 20. In any configuration, agitators 110 may be designed to move stirring elements 111 in complementary patterns 120 that are configured to induce a chaotic advection current within medium 10.

In some embodiments, for example, such a configuration can cause stirring element 111 to move in a pattern that may be substantially a figure-eight shape as illustrated in FIG. 3. Those having ordinary skill in the art will recognize, however, that any of a variety of other movement patterns that result in the one or more stirring elements 111 moving in complementary patterns that are configured to induce a chaotic advection current within the medium, including but not limited to patterns that resemble and X-shape or oval shapes. In some embodiments, the design allows agitators 110 to vary the individual traveling velocities of stirring elements 111, control the relative velocities and/or accelerations of stirring elements 111, and/or produce frequent changes in the direction of movement of stirring elements 111, which individually or together produce a variable shear within medium 10 leading to a chaotic advection current that causes multiple vortices collision. In this regard, complex motion of stirring elements 111 simulates a horseshoe map phenomenon in order to attain improved stirring and mixing by chaotic advection. The chaotic advection induced by the path-crossing currents generated by the motion creates several vortices that vary in diameter but last for a short period of time due to vortex-to vortex-collision. These vortices collisions shorten the existence time of the vortices and cause them to dissipate. Continuous vortex dissipation due to collisions prevents rigid body motion formation, leading to a decrease in rope defect formation and increase in bundle-to-bundle collisions.

### Experimental Design

### Sample Preparations and Experimental Setup

To illustrate the improvement in mat formation, two different sets of carbon fiber mats were processed. The first set was processed using a conventional shear mixer; the second was prepared with the proposed innovative mixing system 100. The conventional shear mixer was used at two stages. First, the mixer is set to a speed of 1500 rpm, then at 300 rpm. These velocities provide a Rₑ>4000 at 1500 RPM and Rₑ<2000 for 300 RPM in an attempt to prevent rope defects formation. Using mixing system 100, the design allows agitators 110 to induce chaotic advection, which causes a variable velocity gradient that leads to improved mixing. In order to study the effect of the mixing time on the fiber dispersion, mats were prepared using total mixing times of 10 min, 20 min and 30 min for each mixing method. In the conventional mixing, the time is split equally between both stages of mixing. Each process was repeated three times in order to study the repeatability of the mixing method.

For the experimental tests, chopped carbon fiber was added at a fiber total volume of 1% of the water volume to not exceed C_{w}. After the desired time of mixing, water was drained by gravity force and the dispersed fibers form a mat (355.6 mm×355.6 mm (14″×14″)) on the screen 22 in the bottom of vessel 20. A vacuum machine may be used to remove excess water then mats may be placed in an Emerson Speed Dryer (Model 145) at 210° F. for 30 minutes to dry.

A high-quality wet laid mat may be measured by its structural uniformity as it affects surface quality, strength, and aesthetic appearance of the mat. X-ray techniques, microscopy and mechanical testing may be used to analyze the dispersion of fibers in the wet laid process. Carbon fiber has an average diameter of 7 μm and low atomic number that makes the use of X-ray technique very challenging to investigate and evaluate the fabricated mats. Moreover, microscopy technique is known to be laborious with an extensive sample preparation. To address these issues, a back light scattering (BLS) technique may be used to characterize the mat pores distribution to investigate fiber density distribution and insure that full fiber dispersion was obtained.

### Results and Discussion

### CFD for New Mixer Design

A Computational Fluid Dynamic (CFD) simulation was conducted using OpenFOAM software version 5.0 using PimpleDyMFoam numerical solver, which uses the hybrid PISO-SIMPLE (PIMPLE) algorithm and dynamic meshing to verify the production of chaotic advection by the proposed mixer. The simulation used 50,240 cells in a finite volume solver, applying Direct Navier Stokes (DNS) for true simulation with continuous fluid and no slip conditions on hard surfaces. The vector orientations presented various orientations demonstrating chaotic advection pattern that has been demonstrated to provide improved mixing as discussed in the theoretical background discussion above. The vessel may be divided into four (4) equal quadrants, and the velocity components are measured at the centers of each quadrant over time. The velocity component may show an irregular pattern associated with chaotic mixing. Furthermore, the number of vortices present in the flow may increase with each cycle of mixing system 100, which may also be indicative of chaotic motion. With every change of the direction of stirring elements 111, a new vortex may be generated, leading to an ever more complex velocity profile. The numerical results support the previously mentioned hypothesis that mixer system 100 is efficient at generating chaotic advection.

### Experimental Results

Mats were produced using both a conventional mixer and mixing system 100 at mixing times of 10 min, 20 min and 30 min as characterized by the back light scattering technique. Qualitative analysis of the mats produced showed the contrast difference of fibers distribution quality between the two methods, especially at 30 min mixing time. Defects, gaps and in general poor distribution was seen with a mat made in a conventional mixer at 30 min mixing time. In contrast, a mat made with mixing system 100 at 30 minutes of mixing time showed no defects with a good fiber distribution. As for time variable within the same method, using conventional mixer, it was observed that longer mixing time resulted in a reduction in the poor distribution. However, rope defects were dominant at 30 min mixing time. The spiral pattern was seen which falls in accordance with the theoretical background explanation of the rigid body motion and that of rope formation during such motion in large diameter vortices. The use of mixing system 100 showed consistent qualitative value throughout the different mixing times.

In order to obtain quantitative measures, images were converted to color maps based on light intensity using code written in MATLAB R2017b. The process starts by defining the mats corners and translating them into a bounding box, so a coordinate system can be drawn for measurements collection. The images were covered by a grid system with each grid cell having the dimensions of 64×64 pixels and associate a value to each pixel based on light intensity threshold on a scale of 0 to 256 on the RGB scale. The resulting images may be measured in percentage of intensity threshold for every pixel with 0 representing total darkness (i.e., lack of fiber dispersion “pores”) and 1 representing maximum RGB value of 256. This quantification allows the numerical measurement of the mat pores distribution presented in a color map format, wherein a value of 1 represents no presence of fibers and that of zero represents no presence of pores in the mat. Mean distribution of the percentage of intensity threshold for pixels in each cell was calculated, as presented in Table 1:

TABLE 1
Mean distribution of mat pores coverage percentage in each region of interest

| | | | Region 1 | | Region 2 | | Region 3 | | Region 4 | | Region 5 | |
|---|---|---|---|---|---|---|---|---|---|---|---|---|
| Average Porosity | | | Mean Avg | Stdv | Mean Avg | Stdv | Mean Avg | Stdv | Mean Avg | Stdv | Mean Avg | Stdv |
| Distribution | | | (%) | (%) | (%) | (%) | (%) | (%) | (%) | (%) | (%) | (%) |
| Conv. | 10 min | Mat 1 | 34.5 | 10.7 | 39.1 | 8.0 | 35 | 12.3 | 14.3 | 15.9 | 40.6 | 12.5 |
| mixer | | Mat 2 | 23.5 | 20.8 | 37.7 | 9.9 | 35.1 | 15.0 | 35.6 | 12.0 | 47.3 | 8.6 |
| | | Mat 3 | 39.7 | 10.2 | 37.0 | 14.2 | 41.4 | 13.2 | 37.1 | 14.4 | 42.0 | 13.1 |
| | 20 min | Mat 1 | 15.9 | 14.8 | 21.9 | 19.0 | 25.2 | 17.6 | 19.8 | 16.9 | 32.0 | 15.5 |
| | | Mat 2 | 33.7 | 10.0 | 25.6 | 13.5 | 27.9 | 11.5 | 26.7 | 10.9 | 35.9 | 9.9 |
| | | Mat 3 | 26.3 | 12.8 | 28.2 | 12.2 | 31.0 | 8.7 | 27.8 | 10.8 | 36.1 | 8.0 |
| | 30 min | Mat 1 | 32.1 | 15.1 | 27.4 | 14.3 | 23.5 | 14.5 | 28.7 | 14.8 | 32.4 | 14.0 |
| | | Mat 2 | 20.1 | 13.5 | 30.4 | 13.6 | 30.0 | 13.6 | 23.6 | 12.3 | 37 | 14.0 |
| | | Mat 3 | 25.6 | 13.8 | 33.7 | 14.2 | 25.1 | 14.1 | 18.6 | 14.4 | 33.2 | 15.2 |
| Mixing | 10 min | Mat 1 | 16.5 | 7.8 | 18.3 | 7.9 | 20.0 | 7.4 | 20.2 | 8.7 | 23.0 | 8.0 |
| system | | Mat 2 | 23.1 | 8.5 | 21.9 | 8.7 | 16.9 | 8.9 | 20.8 | 7.4 | 23.9 | 8.1 |
| 100 | | Mat 3 | 20.3 | 8.6 | 21.0 | 9.6 | 23.0 | 8.0 | 28.1 | 10.3 | 27.6 | 8.9 |
| | 20 min | Mat 1 | 22.7 | 7.0 | 21.4 | 7.2 | 20.2 | 7.4 | 20.6 | 6.7 | 22.5 | 6.8 |
| | | Mat 2 | 20.8 | 8.4 | 19.7 | 8.7 | 17.8 | 8.7 | 19.6 | 6.0 | 24.3 | 9.3 |
| | | Mat 3 | 19.6 | 7.6 | 22 | 6.3 | 22.8 | 7.6 | 23.5 | 5.6 | 22.9 | 7.4 |
| | 30 min | Mat 1 | 20.4 | 8.3 | 14.3 | 9.1 | 16.0 | 8.0 | 14.3 | 7.8 | 22.8 | 8.1 |
| | | Mat 2 | 17.7 | 9.2 | 16.6 | 9.2 | 22.2 | 9.7 | 20.7 | 9.9 | 22.8 | 9.2 |
| | | Mat 3 | 23.0 | 8.0 | 27.5 | 4.8 | 25.8 | 6.5 | 25.0 | 6.6 | 24.3 | 5.2 |

Five regions of interest were selected, with each region measured at 3.5×3.5 inches. All measured percentage of intensity threshold pixel values were compared to the calculated theoretical value. The theoretical value was calculated by considering a perfectly isotropic mat. In such mat, fiber distribution may be equal across all unit areas with equal coverage percentage of fibers. The probability P (n) that any given point is covered by n fibers present per unit area is given by Poisson distribution of the form, see Equation 6:

$$P ( n ) = \frac{{e}^{- k} {k}^{n}}{n !} \qquad Eq . ( 6 )$$

where, k is the total coverage area of fibers per unit area of the plane. Considering that k=nLd, L is the fiber length and d fiber diameter. In order to calculate the theoretical value of mat's pore coverage per unit area, one must consider the value of P(0) where no fibers are present, as given by Equation 7:

$$P ( 0 ) = {e}^{- k} \qquad Eq . ( 7 )$$

The constant k was evaluated at 1.97 for a nonwoven with a basis weight of 215 gsm leading to a value of P(0)=0.14.

Radar plots for mean distribution of the percentage of intensity threshold of pixels representing mat pores coverage percentage in each region of interest were created. It was noticed that mixing using the conventional mixer at 10 min shows a low mat pores coverage percentage of 14.3% in region 4. This result may be due to the fact that fibers clustered in that region due to lack of distribution. While in region 5, the mat pores coverage percentage goes up to 40.7%. A standard deviation graph of the pixels in the region were also created, which indicated a value of 15.9% for region 4 and that of 12.5% for region 5. Standard deviation of the variation of values on the selected portion of the grid above 10% is an indication of the poor fiber distribution. By comparison, the graphs showed that the use of mixing system 100 at 10 min shows higher consistency with values of 20.8% at region 4 and that of 23.9% at region 5 with standard deviations of 8.7% and 8% respectively, providing more trust in the consistency of fiber distribution across the mat. The effect of increasing the time of mixing did not show improvement on the dispersion for the conventional mixer, but alternatively created more rope defects. As an example, the maximum variation may be observed in region 4, as it was 14.3%, 26.7%, 18.6% differences for 10 min, 20 min, and 30 minutes, respectively. However, in using mixing system 100, these values are observed to be 20.8%, 20.6%, 20.7% differences for 10 min, 20 min, and 30 min, respectively, an indication that once dispersion is achieved using mixing system 100, the additional time of mixing had minimal effects on the mat quality.

In order to study the reproducibility of each mixing method, three mats were produced for each mixing time. The use of mixing system 100 showed higher consistency in each region with higher confined standard deviation that did not surpass the 10% value and less than 2% difference in the average mat pores coverage percentage in the same region between different mats. That was true across each of the 5 regions of interest. As for the conventional mixer, the discrepancy in average values of mat pores coverage percentage between the same regions of different mats was more than 20% difference, showing a lack of reproducibility in the mats formed using this method. The use of the conventional mixer showed a large standard deviation values up to 15%, 19%, 18%, 17% and 15% for each of regions 1 to 5, respectively. Despite the consistency of averaged value between all the mats, that is still remarkably high in comparison to the theoretical value. However, the results from using mixing system 100 showed a standard deviation below 2% across all regions in each mat, with a higher consistency in the total mat averaging and closer result to the theoretical value. This provides an indication that mixing system 100 may be equally dispersing the fibers across the entire regions of the mat with high repeatability. It was noticed that all the obtained values are higher than that of theoretical (i.e., an average of 14% and 6% increase for the conventional mixer and mixing system 100, respectively). This can be attributed to the effect of fiber settling with the draining current based on their dimensional size and physical density.

This disclosure is not limited to the particular systems, devices and methods described, as these may vary. The terminology used in the description is for the purpose of describing the particular versions or embodiments only and is not intended to limit the scope.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

As used herein, the term “about” when immediately preceding a numerical value means a range of plus or minus 10% of that value, for example, “about 50” means 45 to 55, “about 25,000” means 22,500 to 27,500, etc., unless the context of the disclosure indicates otherwise, or is inconsistent with such an interpretation.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can, of course, vary. It is also to be understood that the terminology used herein is for the purpose of describing particular embodiments only and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those skilled in the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 compounds. Similarly, a group having 1-5 compounds refers to groups having 1, 2, 3, 4, or 5 compounds, and so forth.

1. A method for forming a composite, the method comprising the steps of:
providing a polymer composite material, the polymer composite material comprising:
electrochemically-synthesized carbon structures derived from CO₂; and
a resin comprising one or more of polyester, epoxy, vinyl ester, phenolic, polyurethane, ABS, polyethylene, polystyrene, biopolyesters, cellulose, biopolyolefins and polycarbonate;
wherein the electrochemically-synthesized carbon structures comprise one or more of carbon nanotubes, carbon black, carbon fibers, carbon zoo, carbon flakes, or carbon spherical particles;
providing a system for dispersing the polymer composite material in a medium, the system comprising:
a vessel configured to receive a volume of a medium including a quantity of fibers;
one or more agitators that each comprise a stirring element that is movable in a pattern within the vessel to mechanically agitate the medium;
a drive system connected to the one or more agitators, the drive system comprising a gear assembly configured to translate rotation of the gear assembly into a pattern of movement for a respective stirring element, the gear assembly comprising:
a drive gear;
a first output gear rotationally coupled to the drive gear;
a second output gear rotationally coupled to the drive gear;
a first connecting arm pivotably coupled to both the first output gear and the stirring element; and
a second connecting arm pivotably coupled to both the second output gear and the stirring element;
wherein the first output gear and the second output gear are configured to drive movement of the stirring element, wherein the pattern of each stirring element of the one or more agitators is configured to cross paths with itself or with a pattern of another stirring element of the one or more agitators within the vessel to generate path-crossing currents that induce a chaotic advection current within the medium, wherein the stirring element is moveable in a pattern comprising a figure-eight pattern or an X-shaped pattern.

2. The method of claim 1, wherein the polymer composite material further comprises one or more cellulosic fibers comprising one or more of bamboo, rice husk, rice straw, sugarcane, pineapple, coconut, cellulose, jute, bagasse, nettle, cotton, hemp, banana, and flax.

3. The method of claim 1, wherein the polymer composite material further comprises one or more of recycled carbon fibers or reclaimed carbon waste fibers.

4. The method of claim 3, wherein one or more of the recycled carbon fibers or reclaimed carbon waste fibers have an average fiber length greater than about 3 mm.

5. The method of claim 1, wherein the polymer composite material comprises one of a fiber reinforced composite or a particle reinforced composite.

6. The method of claim 1, wherein the polymer composite material comprises a sandwich structure wherein at least one layer of the sandwich structure comprises the electrochemically-synthesized carbon structures.

7. The method of claim 1, wherein the polymer composite material further comprises one or more of coupling agents, colorants, plasticizers, fillers, pigments, glass fibers, or flame retardants.

8. The method of claim 1, wherein the one or more agitators are configured to vary traveling velocities of the stirring elements to generate a variable shear within the medium.

9. The method of claim 1, wherein the second output gear is rotationally coupled to the drive gear by an intervening idler gear.
